(19) United States
(12) Patent Application Publication
(10) Pub. No.: US 2006/0037075 A1
(43) Pub. Date: Feb. 16, 2006

(54) Dynamic network detection system and method

(76) Inventors: David E. Frattura, New York, NY (US); Richard W. Graham, Derry, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/066,622

(22) Filed: Feb. 25, 2005

Related U.S. Application Data
(60) Provisional application No. 60/552,000, filed on Mar. 10, 2004.

(51) Int. Cl. G06F 15/173; G06F 12/14

(52) U.S. Cl. 726/22; 709/224

(57) ABSTRACT

A method of dynamically launching a monitor includes monitoring network operations, occurring within a device network, to determine the occurrence of one or more trigger events. One or more event-specific monitor processes are dynamically deployed in response to the occurrence of the one or more trigger events.

### RELATED APPLICATIONS

This application claims the priority of the following application, which is herein incorporated by reference: U.S. Provisional Application Ser. No. 60/552,000 entitled, “Dynamically Created Distributed Monitors in Network Systems”, filed 10 Mar. 2004.

This application herein incorporates by reference the following applications: “Distributed Intrusion Response System”, U.S. patent application Ser. No. 10/713,560 filed Nov. 14, 2003 (attached hereto as Exhibit A) and U.S. Publication No. US20050027837A1, filed Jul. 29, 2003, entitled “System and Method for Dynamic Network Policy Management” (attached hereto as Exhibit B). Both applications are assigned to common assignee Enterasys Networks, Inc.

### FIELD OF THE DISCLOSURE

This disclosure relates to network detection and monitoring systems and methods and, more particularly, to dynamic network detection systems and methods.

### BACKGROUND

Networks, which may be hardwired or wireless, allow for the interconnection of various computing devices (e.g., desktop/laptop computer and servers, for example) and communication devices (e.g., telephones, radios and wireless access points (WAP), for example) and the sharing of data among these devices. Additionally, networks allow multiple devices, and therefore multiple users, to share centralized resources (e.g., network infrastructure, applications, databases, servers, printers, data storage devices, data backup devices, and internet gateways, for example).

Unfortunately, as the access to a network increases, the likelihood of a network attack (i.e., by a hacker or a computer virus, for example) also increases. These attacks may be initiated via various means, such as a surreptitious email attachment, or infected data files copied onto a network drive.

Once initiated, a network attack may result in network harm e.g., data corruption/loss/theft, network access denial, excess/complete network bandwidth consumption, network attack propagation/dissemination, and/or unwarranted or unauthorized use. Currently, there are several generally-available forms of network protection, including firewalls, Intrusion Detection Systems (IDS), Intrusion Prevention Systems (IPS), and dynamic response policy driven systems as referenced earlier.

Firewalls, which are often positioned between a private network (e.g., a corporate computer network) and a public network (e.g., the internet), typically prevent the passage of suspect data packets based on the occurrence of a limited number of specific conditions. Unfortunately, the rigidity of firewalls often limits their usefulness.

Unlike firewalls, which merely prevent the passage of suspect data packets, IDS are designed to initially allow data packet access to the network, such that the usage pattern of the data packets is observed. In the event of potentially harmful behavior by data packet(s), the network administrator is notified. At this point, the network administrator may analyze the situation and take the necessary enforcement action. Unfortunately, as network attacks spread rapidly throughout a network, any delay in taking an enforcement action may increase the severity of the attack. Furthermore, as the network administrator typically defines and implements the enforcement action to be taken, the level of response may not always be applicable with the level of attack. Unfortunately, while some IDS are capable of providing an automated response, these responses are typically minimal and static in nature, often resulting in false alarms, unneeded network shutdowns/slowdowns, and mismatches between levels of attack and levels of response.

Most IPS devices (e.g., firewalls) have a very limited scope of network influence, as they can only block traffic fitting specific criteria that flows through them. Event driven dynamic policy systems attempt to detect interesting and potentially harmful network events using all the input gathering techniques from the above-described methods along with other data collection mechanisms (e.g., RMON, CMON, SMON, for example) to determine a threat severity and, if so configured, take an appropriate response.

Typically, responses are driven by a dynamic distributed policy management approach capable of changing network policy based upon harmful (or potentially harmful) activity. All the approaches typically have some shortcomings demonstrated by the growing frequency of successful attacks. Routinely, the detection methods may indicate anomalous or harmful activity but lack the sophistication to isolate the attack such that the remedy is not as bad as (or worse than) the ongoing attack. Often, additional data is required to verify the extent or specifics of the attack, such as e.g., the origin port, the IP address, the MAC address, the attack location, the protocol, and whether the problem is ongoing or transient. Human intervention is often needed when: complex verification is required to distinguish between attacks and expected network behavior; and/or before implementing a network change that largely impacts network users and applications.

### SUMMARY OF THE INVENTION

According to an aspect of this invention, a method of dynamically launching a monitor includes monitoring network operations, occurring within a device network, to determine the occurrence of one or more trigger events. One or more event-specific monitor processes are deployed in response to the occurrence of the one or more trigger events.

One or more of the following features may also be included. Dynamically deploying one or more event-specific monitor processes may include comparing the one or more trigger events to a monitor rule set. The monitor rule set may define the one or more event-specific monitor processes to be deployed in response to the occurrence of the one or more trigger events. The one or more trigger events may be chosen from the group consisting of: an excessive bandwidth usage, a network fault, a suspect address, a tripwire event, a port scan, a virus detection, an IDS event, a firewall event, an excessive flow rate setup, an unexpected protocol usage, an illegal operation, an authentication and login failure, a link change, and a status change.

The network may include a plurality of network devices and dynamically deploying one or more event-specific monitor processes may include dynamically deploying one or more event specific monitors processes on at least two of the plurality of network devices. One or more of the plurality of network devices may be chosen from the group consisting of: a switch device, a routing device, a bridge, a gateway, an access point, an IDS, an IPS, a firewall, a repeater, a signal forwarding device, a packet forwarding device, a server, an attached function, and an end system.

At least one of the event specific monitor processes may determine the occurrence of one or more suspect network conditions. One or more enforcement processes may be deployed in response to the occurrence of the one or more suspect network conditions. Dynamically deploying one or more enforcement processes may include comparing the one or more suspect network conditions to an enforcement rule set. The enforcement rule set may define the one or more enforcement processes to be deployed in response to the occurrence of the one or more suspect network conditions. One or more of the enforcement processes may be chosen from the group consisting of: temporarily disabling user access; permanently disabling user access; disconnecting a network user; suspending a network user, requiring that a network user reauthenticate; limiting the bandwidth of a network device; limiting the bandwidth of an application; quarantining a network user; filtering network traffic; redirecting network traffic; logging network traffic; mirroring port traffic; making network topology changes; sending network alerts; initiating network traps; and terminating network device sessions.

Dynamically deploying one or more event-specific monitor processes may include dynamically deploying at least two serial monitor processes. A first serial monitor process may generate a first set of suspect network conditions, and a second serial monitor process may generate a second set of suspect network conditions chosen from the first set of suspect network conditions. One or more enforcement processes may be deployed in response to the occurrence of the second set of suspect network conditions.

Dynamically deploying one or more event-specific monitor processes may include dynamically deploying at least two parallel monitor processes. A first parallel monitor process may generate a first set of suspect network conditions, and a second parallel monitor process may generate a second set of suspect network conditions. A third set of suspect network conditions may be generated that is the intersection of the first and second sets of suspect network conditions. One or more enforcement processes may be deployed in response to the occurrence of the third set of suspect network conditions.

Dynamically deploying one or more event-specific monitor processes may include dynamically deploying at least two parallel monitor processes. A first parallel monitor process may generate a first set of suspect network conditions. A second parallel monitor process may generate a second set of suspect network conditions. A third set of suspect network conditions may be generated that is the union of the first and second sets of suspect network conditions. One or more enforcement processes may be deployed in response to the occurrence of the third set of suspect network conditions.

The device network may be a distributed computing network and/or a telephony network.

According to an aspect of this invention, a method of dynamically launching a monitor includes monitoring network operations, occurring within a device network, to determine the occurrence of one or more trigger events. Network operations on a network device coupled to the device network are locally monitored in response to the occurrence of the one or more trigger events.

One or more of the following features may also be included. Locally monitoring network operations may include comparing the one or more trigger events to a monitor rule set. The monitor rule set may define one or more event-specific monitor processes to be deployed in response to the occurrence of the one or more trigger events. Locally monitoring network operations may include dynamically deploying the one or more event-specific monitor processes on the network device in response to the occurrence of the one or more trigger events. At least one of the event specific monitor processes may determine the occurrence of one or more suspect network conditions. One or more enforcement processes may be deployed in response to the occurrence of the one or more suspect network conditions.

The above-described methods may also be implemented as a sequence of instructions executed by a processor.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a block diagram of a system including a dynamic detection system;

FIG. 2 is a block diagram of the dynamic detection system of FIG. 1; and

FIG. 3 is a diagrammatic view of the dynamic detection system of FIG. 1.

### DETAILED DESCRIPTION OF THE PREFERRED EMBODIMENTS

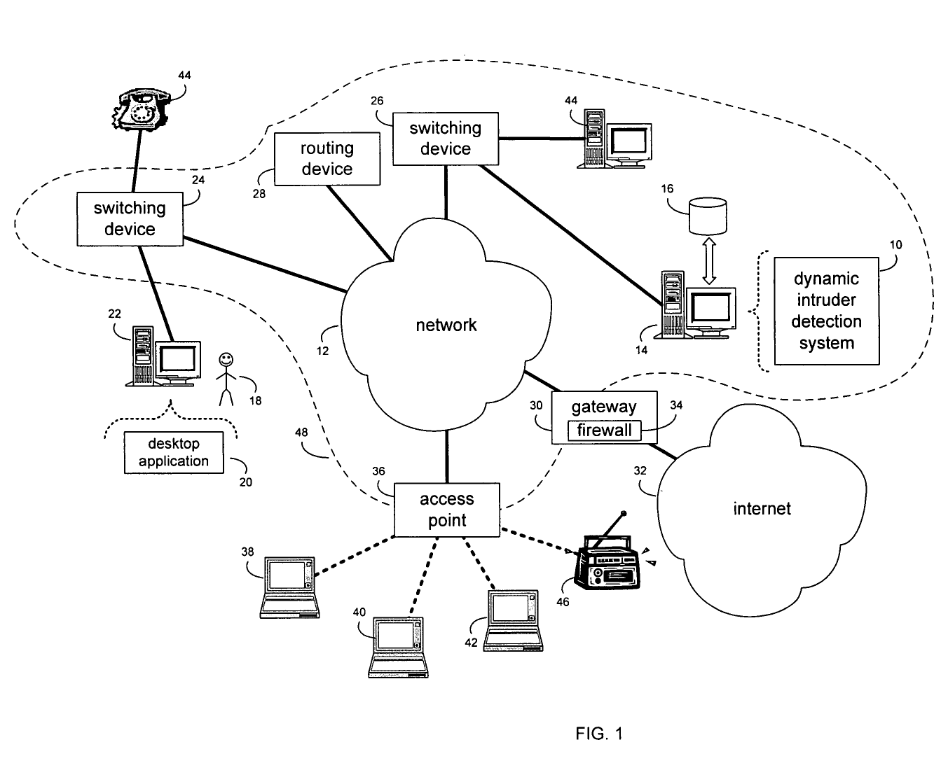

Referring to FIG. 1, there is shown a dynamic detection system 10 that monitors network traffic (e.g., data packets) on a network 12 to detect and analyze network events, and may execute one or more enforcement measures in response to the occurrence of a network event.

Dynamic detection system 10 typically resides on and is executed by one or more computing devices (e.g., server 14) connected to network 12 (e.g., a local area network, an intranet, the internet, or some other form of network). The instruction sets and subroutines of dynamic detection system 10 are typically stored on a storage device 16 connected to computing device 14.

Storage device 16 may be, for example, a hard disk drive, a tape drive, an optical drive, a RAID array, a random access memory (RAM), or a read-only memory (ROM). A network administrator 18 typically configures, accesses, and administers dynamic intruder detection system 10 through a desktop application 20 (e.g., Microsoft Internet Explorer™, Netscape Navigator™, or a specialized user interface) running on a computer 22 that is also connected to the network 12.

Various network devices may be a part of network 12, such as: switching devices 24, 26 (i.e., a device that examines each data packet to determine, from a physical address such as a MAC address, the intended recipient of the data packet); a routing device 28 (i.e., a device that determines the next network point to which a data packet should be forwarded toward its destination); a gateway 30 (i.e., a device that functions as an entrance to another network, e.g., the internet 32), which often includes a firewall 34 (i.e., a program or set of programs that protects a private network from users of other networks); and a wireless access point (WAP) 36 (i.e., a device that allows for wireless communication of data between the access point 36 and one or more computing devices 38, 40, 42), for example. Additional devices include bridges (not shown), Intrusion Detection Systems (not shown), Intrusion Prevention Systems (not shown), repeaters (not shown), signal forwarding devices (not shown), a packet forwarding devices (not shown), attached functions (not shown), and end systems (not shown). Additionally, non-traditional computing devices, such as IP (i.e., internet protocol) telephones 44 and IP radios 46, may also be connected to network 12.

Typically, each network system (e.g., network 12) is considered to have a core 48, having a greater level of physical security and higher bandwidth interconnecting other network elements.

Each network device 24, 26, 28, 30, 36 is typically capable of bidirectional communication with dynamic detection system 10. Further, each network device is typically capable of executing one or more event specific monitor processes, which are controlled by and provide data to dynamic detection system 10 (as will be discussed below in greater detail).

Since there are numerous methods/algorithms that are used to analyze network traffic for the signs of inappropriate actions, malicious use or other harm of network resources, it is essentially impracticable to employ all of these methods and/or algorithms on a single network device, such as switching devices 24, 26, router 28, gateway 30, or access point 36.

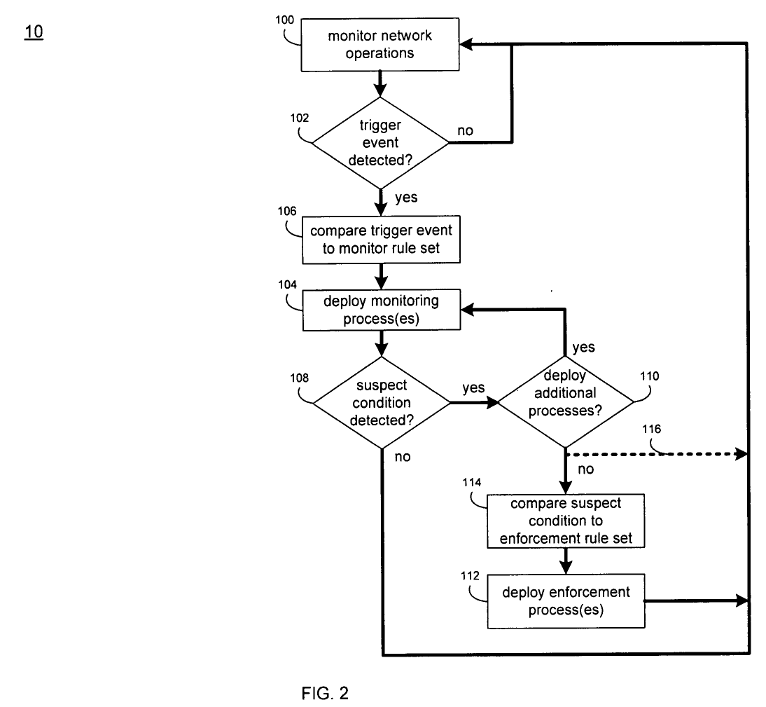

Referring also to FIG. 2, dynamic detection system 10 monitors 100 the network operations (e.g., traffic patterns, sender/recipient addresses, attachment names, and packet contents, for example) using basic packet, signal and flow detection methods to determine the occurrence of one or more trigger events (e.g., an excessive bandwidth usage, network faults, a suspect address, a tripwire event, port scanning, virus detection, IDS event, firewall event, excessive flow rate setups, unexpected protocol usage, illegal operations, authentication and login failures, link changes, status changes human initiated or manual operations and many other events including legitimate and expected operations which might be a precursor to an attack. A trigger event is an event that is indicative of a suspicious network event, e.g., a network intrusion (e.g., the presence of a network hacker), a virus propagation (e.g., the propagation of the MS Blaster WORM virus), the occurrence of a prohibited network activity (e.g., the downloading of MP3 files), or a high port-usage event, for example.

Assume for illustrative purposes that dynamic detection system 10 is configured to monitor network 12 to detect intrusion/virus events. As stated above, dynamic detection system 10 typically uses basic flow detection methods/algorithms to monitor network operations to detect the occurrence of one or more trigger events. Unfortunately, while the basic flow detection methods/algorithms are efficient at detecting high-level trigger events, quite often these trigger events are false alarms.

Accordingly, in the event that dynamic detection system 10 detects 102 a trigger event (which may or may not be indicative of an intrusion/virus event), dynamic detection system 10 deploys 104 one or more event-specific monitor processes that determine whether the trigger event is indicative of a suspect network operation (which in this example is an intrusion/virus event) or merely a false alarm.

The quantity and type of event-specific monitor processes deployed varies in accordance with the type of trigger event(s) detected by dynamic detection system 10. Continuing with the above-stated example, assume that the trigger event detected is a sudden increase in the level of MS SQL traffic within network 12. Dynamic detection system 10 compares 106 this detected trigger event to a monitor rule set to determine which (if any) intrusion/virus event(s) may be occurring. In this example, the monitor rule set would correlate detected trigger events to possible intrusion/virus events. Since a sudden increase in MS SQL traffic may be indicative of the propagation of the MS Blaster WORM virus on network 12, trigger event comparison 106 would result in the deployment 104 of event-specific monitor processes designed to verify the existence of the MS Blaster WORM virus on network 12, as opposed to the occurrence of a false alarm due to e.g., a network user performing a high-level of SQL database read/write operations.

An example of such an event-specific monitor process is a pattern matching process that analyzes individual data packets to see if the data within the data packet matches a defined and known pattern for the MS Blaster WORM virus. While a pattern matching process is computationally intensive, since the data packets are being examined for the existence of a single known pattern (as opposed to a known pattern for each of the thousands of known viruses), computational loading is manageable.

When dynamically deploying event-specific monitor processes, dynamic detection system 10 may transmit the event specific monitor processes to other network devices (e.g., switching device 24) for remote execution, and/or may execute the event-specific monitor process locally (i.e., on server 14). Continuing with the above-stated example, when dynamic detection system 10 deploys the event-specific monitor process (i.e., the pattern matching process), the process is typically deployed to and executed on all network devices (i.e., in this example, switching devices 24, 26, router 28, gateway 30, and access point 36). However, the number of network devices executing the event-specific monitor process may be reduced to target only highly-vulnerable devices. And, as stated above, the device (e.g., server 14) executing dynamic detection system 10, as well as any other attached computing device (e.g., computing devices 22, 38, 40, 42, 44), may also execute the event specific monitor processes.

Once deployed and executed, the event-specific monitor processes perform their designated functions to determine 108 whether or not a suspect network condition is present and provide feedback to dynamic detection system 10. Continuing with the above-stated example, the event-specific monitor process performs a pattern matching function to determine 108 whether the suspect network condition (i.e., in this example, MS Blaster virus) is present within network 12. In the event that one or more of the event specific monitor processes concludes that the MS Blaster WORM virus is present within the network, data is provided to dynamic detection system 10 confirming the presence of the virus.

In response to receiving such confirmation, dynamic detection system 10 may deploy 110 additional event-specific monitoring processes to further confirm and reinforce the existence of, in this example, the MS Blaster WORM virus. The value in dynamically deploying additional event-specific monitor processes is that successive confirmations can create a higher likelihood of accuracy and extent.

Once the existence of, in this example, the MS Blaster WORM virus is confirmed, dynamic detection system 10 may deploy 112 one or more enforcement processes that resolve/mitigate the effect(s) of the suspect network condition(s), such that the quantity and type of enforcement processes deployed vary in accordance with the type of suspect network conditions(s) detected by the event-specific monitor processes dynamically deployed by dynamic detection system 10. Accordingly, dynamic detection system 10 compares 114 the suspect network condition to an enforcement rule set to determine which enforcement process(es) should be deployed.

Additionally, it is possible for the existence of a suspect network condition not to require deployment of an enforcement process. For example, suppose a network administrator is simply interested in determining the point during the day at which the average port utilization of a switch exceed 70% (for purposes of determining network traffic patterns). When the monitor process determines that this condition has occurred, the monitor process may simply notify the system administrator and terminate operation (as indicated by phantom line 116) without deploying an enforcement process.

Continuing with the above-stated example, the suspect network condition is the confirmation of the presence of the MS Blaster WORM virus on network 12. Accordingly, the enforcement process(es) deployed may include: disabling access temporarily or completely, disconnecting a network user, forcing user re-authentication, limiting the bandwidth of a network device or application, quarantining, filtering traffic, redirecting network traffic, mirroring port traffic, filtering or limiting traffic based on protocols and or applications or fields and signals within the traffic, logging all traffic, making network topology changes, sending alerts or traps, terminating device sessions, and/or other changes to network access or uses.

When deploying 104 event-specific monitor processes, they may be deployed in groups, such as in a serial fashion. For example, in certain situations, it may be desirable to examine the data files attached to email received by a mail server (attached to network 12) to determine which (if any) email has an attachment named “msblaster.exe”. This would result in the generation of a first set of suspect network conditions (i.e., the list of email containing attachments named “msblaster.exe”). A second serial event-specific monitor process may perform a pattern matching function to determine which of the suspect network conditions (i.e., the email containing attachments named “msblaster.exe”) are conclusively infected with the MS Blaster WORM virus, thus creating a second set of suspect network conditions that is a subset of the first set of suspect network conditions. Additional event-specific monitor processes may be deployed to further enhance the accuracy of the results. Dynamic detection system 10 may then deploy 112 one or more enforcement processes that resolve/mitigate the effect(s) of the second set of suspect network conditions.

Alternatively, multiple event-specific monitor processes may be deployed 104 in a parallel fashion. For example, the first parallel event-specific monitor process may determine which (if any) email messages have an attachment named “msblaster.exe” (creating a first set of suspect network conditions). A second event-specific monitor process may perform a pattern matching function to determine which (if any) data packets are infected with the MS Blaster WORM virus (creating a second set of suspect network conditions which is independent of the first set of suspect network conditions). Dynamic detection system 10 may then generate a third set of suspect network conditions that is a mathematical function (e.g., an intersection or a union) of the first and second sets of suspect network conditions. Dynamic detection system 10 may then deploy 112 one or more enforcement processes that resolve/mitigate the effect(s) of the third set of suspect network conditions.

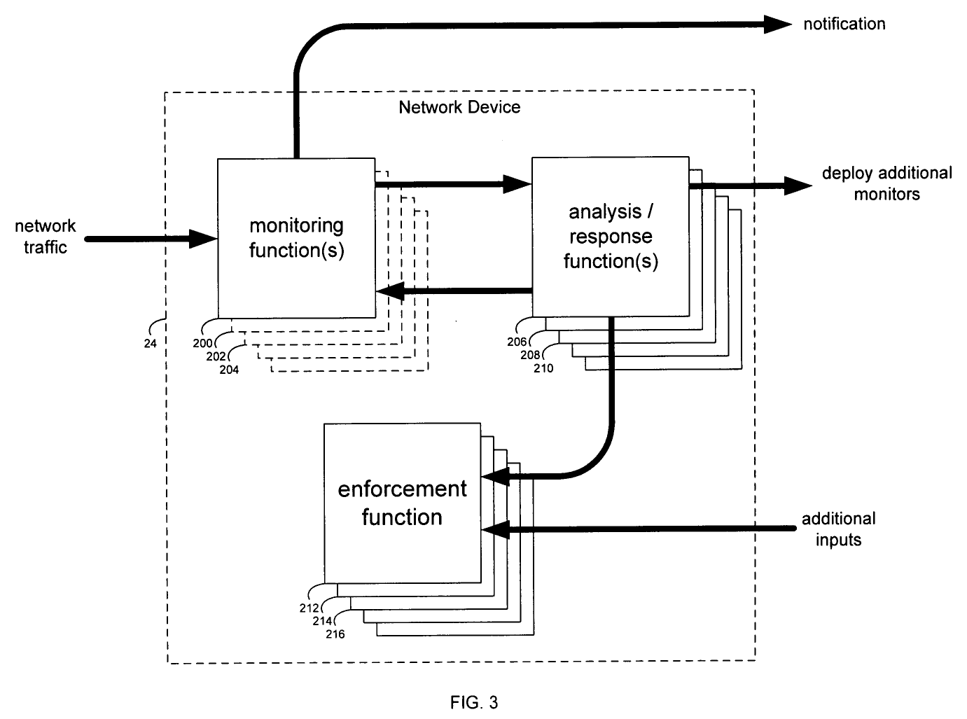

Referring also to FIG. 3, there is shown a diagrammatic view of dynamic detection system 10 operating on a network device (e.g., switching device 24, 26, router device 28, gateway 30, or access point 36, for example). As discussed above, dynamic detection system 10 performs several functions, including one or more monitoring functions 200, 202, 204, one or more analysis/response functions 206, 208, 210, and one or more enforcement functions 212, 214, 216, each of which will be discussed below in the following examples.

Assume that a network switching device 24 executes a first monitoring function 200 that implements a basic flow detection algorithm that (while not highly accurate) consumes minimum resources (i.e., has little impact upon the operation of switching device 24). These monitoring functions may be deployed by default (i.e., always functioning) or (as discussed above) may be deployed due to the occurrence of a specific event. Example of these detection algorithms include RMON (i.e., a remote monitoring function) and SMON (i.e., a switched network monitoring function). Additionally, switching device 24 may support highly-accurate detection algorithms (e.g., intrusion detection systems, stateful anomaly detection systems, and/or per data flow monitoring functions, for example) which are based on advanced algorithms and are highly accurate, but also consume significant switch resources.

Once deployed, first monitoring function 200 may: send an event flag on detection of an event; wait to be polled; count the number of events detected continuously; count events/monitor events for a defined period of time; send a flag after the occurrence of a defined number of events (but keep counting); send a flag after the occurrence of a defined group of events; and/or run until automatically or manually terminated, for example.

First analysis/response function 206 interprets the data provided by first monitoring function 200. In this example, first monitoring function 200 is in operation by default (i.e., always functioning). When first monitoring function 200 observes a possible event (i.e., a trigger event), first monitoring function 200 notifies first analysis/response function 206. First analysis/response function 206 then analyzes and interprets the data received from first monitoring function 200. This analysis and interpretation may be performed in many different ways (e.g., comparing a trigger event detected to a monitor rule set, for example).

If it is determined that additional inquiry is needed, first analysis/response function 206 may deploy one or more additional monitoring functions (e.g., monitoring functions 202, 204) that utilize a more comprehensive monitoring algorithm. Examples of comprehensive monitoring algorithms that could be dynamically enabled include intrusion detection systems with specifically tuned signatures or the stateful inspection of a specific flow and/or the response flow. Dynamic detection system 10 may deploy additional monitor functions if further investigation is warranted/needed. Once sufficiently certain, one or more enforcement functions (e.g., enforcement functions 212, 214, 216) may be deployed. As discussed above, examples of these enforcement functions include: disabling access temporarily or completely, disconnecting a network user, forcing user re-authentication, limiting the bandwidth of a network device or application, quarantining, filtering traffic, redirecting network traffic, mirroring port traffic, filtering or limiting traffic based on protocols and or applications or fields and signals within the traffic, logging all traffic, making network topology changes, sending alerts or traps, terminating device sessions or other changes to network access or uses.

The dynamic functionality of system 10 allows for monitor functions, analysis/response functions, and enforcement functions to be located on a single network device (e.g., switching device 24) or distributed across multiple devices (e.g., monitor and analysis/response functions on server 14 and enforcement functions on switching device 24).

The dynamic functionality of system 10 further allows for monitor functions, analysis/response functions, and enforcement functions to be located on a single network device (e.g., switching device 24) or distributed across multiple devices (e.g., monitor and analysis/response functions on server 14 and enforcement functions on switching device 24).

As a further example, assume that a monitor function (i.e., an uplink egress monitor function) executes (by default) on network switching device 24 and examines all input ports to determine the occurrence of a certain input event. Upon detecting this event, system 10 may deploy additional monitor functions to determine the specific input port on which the event was detected. After determining the specific input port, additional monitors may be deployed to capture the source address of any device responding to the detected input port event.

Accordingly, the deployment of one or more simple monitoring functions can aid in quickly isolating the origin of a very sophisticated event, or gaining the confirming evidence of the intent of an action or set of network actions. Therefore, local devices under the coordination of central analysis and management may be directed to determine if a device or action is local within the network device (i.e., one of perhaps hundreds in the network) and then, with additional dynamic monitor functions under local control, isolate the exact port and other pertinent information.

While the dynamic detection system is described above as being executed on a server, other configurations are possible. For example, the dynamic detection system may be executed on any other network device, such as a switching device, routing device, gateway, or access point.

While the dynamic detection system is described above as being executed on a network device connected to a distributed computing network, other configurations are possible. For example, the dynamic detection system may be executed on a device connected to a telephony network, such as telephones, switches, servers, and PBX (i.e., public branch exchange) devices, for example.

While the dynamic detection system is described above as being used to detect intrusion/virus events, other configurations are possible, such as the control and regulation of network traffic.

For example, most modern routing protocols (by default) typically route network traffic through a network port having the comparatively highest bandwidth rating. For example, if a network switching device has two ports, a low-speed 100 Mbit/second port and a high speed 1000 Mbit/second port, typically most (if not all) network traffic (e.g., data packets) are routed through the 1000 Mbit/second port, with the 100 Mbits/second port operating in a standby mode.

However, it may be useful or desirable to route a portion of the network traffic through the low speed port. Accordingly, the administrator may configure the dynamic detection system to deploy an event specific monitor process to monitor the bandwidth consumption rate on the 1000 Mbits/second port. This monitor process would then provide feedback to the dynamic detection system and, in the event that the consumption reaches a predefined threshold, an enforcement process is deployed. For example, assuming that the administrator defines the bandwidth threshold as 70% utilization of the 1000 Mbit/second port (i.e., 700 Mbit/second bandwidth consumption), upon receiving feedback from the event-specific monitor process indicating a consumption level that meets or exceeds this threshold, an enforcement process may be deployed that routes all world wide web traffic onto the low speed 100 Mbit/second port. The event-specific monitor process may be configured to continue to monitor the bandwidth consumption of the low speed 100 Mbit/second port and the high speed 1000 Mbit/second port to determine if the sum of the bandwidth consumptions is less than 70% of the high speed 1000 Mbit/second port. If the event that the sum falls below the threshold level of 70%, the enforcement process that routes all world wide web traffic through the low speed port may be cancelled.

A number of implementations have been described. Nevertheless, it will be understood that various modifications may be made. Accordingly, other implementations are within the scope of the following claims.

What is claimed is:

1. A method of dynamically launching a monitor comprising:
monitoring network operations, occurring within a device network, to determine the occurrence of one or more trigger events; and
dynamically deploying one or more event-specific monitor processes in response to the occurrence of the one or more trigger events.

2. The method of claim 1 wherein dynamically deploying one or more event-specific monitor processes includes:
comparing the one or more trigger events to a monitor rule set, wherein the monitor rule set defines the one or more event-specific monitor processes to be deployed in response to the occurrence of the one or more trigger events.

3. The method of claim 1 wherein one or more of the trigger events is chosen from the group consisting of: an excessive bandwidth usage, a network fault, a suspect address, a tripwire event, a port scan, a virus detection, an IDS event, a firewall event, an excessive flow rate setup, an unexpected protocol usage, an illegal operation, an authentication and login failure, a link change, and a status change.

4. The method of claim 1 wherein the network includes a plurality of network devices and dynamically deploying one or more event-specific monitor processes includes:
dynamically deploying one or more event specific monitor processes on at least two of the plurality of network devices.

5. The method of claim 4 wherein one or more of the plurality of network devices is chosen from the group consisting of: a switch device, a routing device, a bridge, a gateway, an access point, an IDS, an IPS, a firewall, a repeater, a signal forwarding device, a packet forwarding device, a server, an attached function, and an end system.

6. The method of claim 1 wherein at least one of the event specific monitor processes determines the occurrence of one or more suspect network conditions, the method further comprising:
dynamically deploying one or more additional event-specific monitor processes in response to the occurrence of the one or more suspect network conditions.

7. The method of claim 1 wherein at least one of the event specific monitor processes determines the occurrence of one or more suspect network conditions, the method further comprising:
dynamically deploying one or more enforcement processes in response to the occurrence of the one or more suspect network conditions.

8. The method of claim 7 wherein dynamically deploying one or more enforcement processes includes:
comparing the one or more suspect network conditions to an enforcement rule set, wherein the enforcement rule set defines the one or more enforcement processes to be deployed in response to the occurrence of the one or more suspect network conditions.

9. The method of claim 7 wherein one or more of the enforcement processes is chosen from the group consisting of: temporarily disabling user access; permanently disabling user access; disconnecting a network user; suspending a network user, requiring that a network user reauthenticate; limiting the bandwidth of a network device; limiting the bandwidth of an application; quarantining a network user; filtering network traffic; redirecting network traffic; logging network traffic; mirroring port traffic; making network topology changes; sending network alerts; initiating network traps; and terminating network device sessions.

10. The method of claim 1 wherein dynamically deploying one or more event-specific monitor processes includes:
dynamically deploying at least two serial monitor processes,
wherein a first serial monitor process generates a first set of suspect network conditions, and
wherein a second serial monitor process generates a second set of suspect network conditions chosen from the first set of suspect network conditions.

11. The method of claim 10 further comprising:
dynamically deploying one or more enforcement processes in response to the occurrence of the second set of suspect network conditions.

12. The method of claim 1 wherein dynamically deploying one or more event-specific monitor processes includes:
dynamically deploying at least two parallel monitor processes, wherein a first parallel monitor process generates a first set of suspect network conditions, and a second parallel monitor process generates a second set of suspect network conditions; and
generating a third set of suspect network conditions that is the intersection of the first and second sets of suspect network conditions.

13. The method of claim 12 further comprising:
dynamically deploying one or more enforcement processes in response to the occurrence of the third set of suspect network conditions.

14. The method of claim 1 wherein dynamically deploying one or more event-specific monitor processes includes:
dynamically deploying at least two parallel monitor processes, wherein a first parallel monitor process generates a first set of suspect network conditions, and a second parallel monitor process generates a second set of suspect network conditions; and
generating a third set of suspect network conditions that is the union of the first and second sets of suspect network conditions.

15. The method of claim 14 further comprising:
dynamically deploying one or more enforcement processes in response to the occurrence of the third set of suspect network conditions.

16. The method of claim 1 wherein the device network is a distributed computing network.

17. The method of claim 1 wherein the device network is a telephony network.

18. A computer program product residing on a computer readable medium having a plurality of instructions stored thereon which, when executed by a processor, causes that processor to:
monitor network operations, occurring within a device network, to determine the occurrence of one or more trigger events; and
dynamically deploy one or more event-specific monitor processes in response to the occurrence of the one or more trigger events.

19. The computer program product of claim 18 wherein the instructions for dynamically deploying one or more event-specific monitor processes include instructions for:
comparing the one or more trigger events to a monitor rule set, wherein the monitor rule set defines the one or more event-specific monitor processes to be deployed in response to the occurrence of the one or more trigger events.

20. The computer program product of claim 18 wherein one or more of the trigger events is chosen from the group consisting of: an excessive bandwidth usage, a network fault, a suspect address, a tripwire event, a port scan, a virus detection, an IDS event, a firewall event, an excessive flow rate setup, an unexpected protocol usage, an illegal operation, an authentication and login failure, a link change, and a status change.

21. The computer program product of claim 18 wherein the network includes a plurality of network devices and the instructions for dynamically deploying one or more event-specific monitor processes include instructions for:
dynamically deploying one or more event specific monitors processes on at least two of the plurality of network devices.

22. The computer program product of claim 21 wherein one or more of the plurality of network devices is chosen from the group consisting of: a switch device, a routing device, a bridge, a gateway, an access point, an IDS, an IPS, a firewall, a repeater, a signal forwarding device, a packet forwarding device, a server, an attached function, and an end system.

23. The computer program product of claim 18 wherein at least one of the event specific monitor processes determines the occurrence of one or more suspect network conditions, the computer program product further comprising instructions for:
dynamically deploying one or more additional event-specific monitor processes in response to the occurrence of the one or more suspect network conditions.

24. The computer program product of claim 18 wherein at least one of the event specific monitor processes determines the occurrence of one or more suspect network conditions, the computer program product further comprising instructions for:
dynamically deploying one or more enforcement processes in response to the occurrence of the one or more suspect network conditions.

25. The computer program product of claim 24 wherein the instructions for dynamically deploying one or more enforcement processes includes instruction for:
comparing the one or more suspect network conditions to an enforcement rule set, wherein the enforcement rule set defines the one or more enforcement processes to be deployed in response to the occurrence of the one or more suspect network conditions.

26. The computer program product of claim 24 wherein one or more of the enforcement processes is chosen from the group consisting of: temporarily disabling user access; permanently disabling user access; disconnecting a network user; suspending a network user, requiring that a network user reauthenticate; limiting the bandwidth of a network device; limiting the bandwidth of an application; quarantining a network user; filtering network traffic; redirecting network traffic; logging network traffic; mirroring port traffic; making network topology changes; sending network alerts; initiating network traps; and terminating network device sessions.

27. The computer program product of claim 18 wherein the instructions for dynamically deploying one or more event-specific monitor processes include instructions for:
dynamically deploying at least two serial monitor processes,
wherein a first serial monitor process generates a first set of suspect network conditions, and
wherein a second serial monitor process generates a second set of suspect network conditions chosen from the first set of suspect network conditions.

28. The computer program product of claim 27 further comprising instructions for:
dynamically deploying one or more enforcement processes in response to the occurrence of the second set of suspect network conditions.

29. The computer program product of claim 18 wherein the instructions for dynamically deploying one or more event-specific monitor processes include instructions for:
dynamically deploying at least two parallel monitor processes, wherein a first parallel monitor process generates a first set of suspect network conditions, and a second parallel monitor process generates a second set of suspect network conditions; and
generating a third set of suspect network conditions that is the intersection of the first and second sets of suspect network conditions.

30. The computer program product of claim 29 further comprising instructions for:
dynamically deploying one or more enforcement processes in response to the occurrence of the third set of suspect network conditions.

31. The computer program product of claim 18 wherein the instructions for dynamically deploying one or more event-specific monitor processes include instructions for:
dynamically deploying at least two parallel monitor processes, wherein a first parallel monitor process generates a first set of suspect network conditions, and a second parallel monitor process generates a second set of suspect network conditions; and
generating a third set of suspect network conditions that is the union of the first and second sets of suspect network conditions.

32. The computer program product of claim 31 further comprising instructions for:
dynamically deploying one or more enforcement processes in response to the occurrence of the third set of suspect network conditions.

33. The computer program product of claim 18 wherein the device network is a distributed computing network.

34. The computer program product of claim 18 wherein the device network is a telephony network.

35. A method of dynamically launching a monitor comprising:
monitoring network operations, occurring within a device network, to determine the occurrence of one or more trigger events; and
locally monitoring, network operations on a network device coupled to the device network in response to the occurrence of the one or more trigger events.

36. The method of claim 35 wherein locally monitoring network operations includes:
comparing the one or more trigger events to a monitor rule set, wherein the monitor rule set defines one or more event-specific monitor processes to be deployed in response to the occurrence of the one or more trigger events.

37. The method of claim 36 wherein locally monitoring network operations further includes:
dynamically deploying the one or more event-specific monitor processes on the network device in response to the occurrence of the one or more trigger events.

38. The method of claim 37 wherein at least one of the event specific monitor processes determines the occurrence of one or more suspect network conditions, the method further comprising:
dynamically deploying one or more enforcement processes in response to the occurrence of the one or more suspect network conditions.

39. A computer program product residing on a computer readable medium having a plurality of instructions stored thereon which, when executed by a processor, causes that processor to:
monitor network operations, occurring within a device network, to determine the occurrence of one or more trigger events; and
locally monitor network operations on a network device coupled to the device network in response to the occurrence of the one or more trigger events.

40. The computer program product of claim 39 wherein the instructions for locally monitoring network operations include instructions for:
comparing the one or more trigger events to a monitor rule set, wherein the monitor rule set defines one or more event-specific monitor processes to be deployed in response to the occurrence of the one or more trigger events.

41. The computer program product of claim 40 wherein the instructions for locally monitoring network operations further include instructions for:
dynamically deploying the one or more event-specific monitor processes on the network device in response to the occurrence of the one or more trigger events.

42. The computer program product of claim 41 wherein at least one of the event specific monitor processes determines the occurrence of one or more suspect network conditions, the computer program product further comprising instructions for:
dynamically deploying one or more enforcement processes in response to the occurrence of the one or more suspect network conditions.
